(19) United States
(12) Patent Application Publication
(10) Pub. No.: US 2018/0252009 A1
(43) Pub. Date: Sep. 6, 2018

(54) HANDLE DEVICE FOR A MOTOR VEHICLE

(71) Applicant: Huf Hülsbeck & Fürst GmbH & Co. KG, Velbert (DE)

(72) Inventors: Martin Porada, Wuppertal (DE); Mensur Velicanin, Velbert (DE)

(73) Assignees: Huf Hülsbeck & Fürst GmbH & Co. KG, Velbert (DE); Huf Hülsbeck & Fürst GmbH & Co. KG, Velbert (DE)

(21) Appl. No.: 15/760,117

(22) PCT Filed: Aug. 17, 2016
(86) PCT No.: PCT/EP2016/069477

§ 371 Date: Mar. 14, 2018

(30) Foreign Application Priority Data
Sep. 16, 2015 (DE) 102015011778.5
Sep. 17, 2015 (DE) 102015115673.3

(51) Int. Cl. E05B 85/10

(52) U.S. Cl. CPC E05B 85/107; E05B 85/103

(57) ABSTRACT

A handle device for a motor vehicle includes a door handle, at least one operating lever that is pivotably supported about a first axle, a support for supporting the door handle, and at least one actuating lever for coupling the door handle to the support, wherein the actuating lever pivots about a second axle. A first bearing section is located on the support for supporting the operating lever, a second bearing section is located on the support for supporting the second axle, at least one guide element guides the door handle and/or the operating lever, a drive moves the operating lever and/or the actuating lever, and a door lock is coupled to the door handle. The first axle is arranged so as to slide in the first bearing section and the second axle is arranged in a fixed location in the second bearing section in an installed state.

### TECHNICAL FIELD

The invention relates to a handle device for a motor vehicle.

Various handle devices for motor vehicles are known from the prior art. Especially in the case of flush-mounted outside door handles, which are located within the motor vehicle door when in the unoperated state, elaborate designs for extending the door handle are used that have a multiplicity of levers. This requires a relatively large installation space, which is no longer available in modern motor vehicles due to the demands for weight saving. Furthermore, an economical design can be executed only with difficulty when multiple levers are used.

The object of the invention is therefore to provide a simple and economical design for a handle device.

### BACKGROUND

The object is attained by patent claim 1. Consequently, a handle device for a motor vehicle has:
a door handle
at least one operating lever that is supported so as to pivot about a first axle,
a support for supporting the door handle,
at least one actuating lever for coupling the door handle to the support, wherein the actuating lever is supported so as to pivot about a second axle,
a first bearing section located on the support for supporting the operating lever,
a second bearing section located on the support for supporting the second axle,
at least one guide element for positive guidance of the door handle and/or of the operating lever,
a drive, in particular an electric motor, for moving the operating lever and/or the actuating lever, and
a door lock that is coupled to the door handle, wherein the first axle is arranged so as to slide in the first bearing section, and the second axle is arranged in a fixed location in the second bearing section in the installed state. As a result of this measure, the costs for the design are lowered and the installation of the handle device is simplified. Moreover, less installation space is needed in the motor vehicle door due to the small number of levers, thereby ensuring firstly that the door handle can be extended in an operating position and secondly that in the operating position the door handle can be pivoted in the clockwise direction by means of the operating lever to open the door lock, specifically without having the door handle make contact with the outside door panel of the motor vehicle door.

According to one preferred embodiment, provision is made that the actuating lever is longer than the operating lever in design. This has the advantage that the door handle can be extended from the motor vehicle door substantially linearly, which is to say parallel to the plane of the ground.

According to another preferred embodiment, provision is made that the actuating lever is twice as long as the operating lever in design. This ensures that the motion of the door handle out of the motor vehicle door always takes place linearly.

According to another preferred embodiment, provision is made that the actuating lever is implemented as a separate part and is frictionally and/or positively connected to the door handle. This measure ensures simpler installation. At least the operating lever and the actuating lever can be provided as a coupled assembly that is installed on the inside of the door. The door handle is pushed through an opening in the motor vehicle door from the outside and is connected to the operating lever. The connection of the door handle to the operating lever can be implemented as a clip connection, snap-in connection, adhesive connection, screw connection, or plug-in connection. Other connections not listed here are likewise possible.

According to another preferred embodiment, provision is made that the eccentric element has a pin, in particular a cylindrical pin, wherein the pin serves to drive the actuating lever. The eccentric element thus has a dual function, because the eccentric element serves firstly to move the actuating lever and secondly to move the operating lever, so additional cost-intensive components can be dispensed with in advantageous fashion. The design is very simple and economical when the operating lever and the door handle are implemented as a single part. The door handle including the operating lever could be produced in one piece as an injection-molded part.

According to another preferred embodiment, provision is made that the first bearing section has an actuation stop that serves to stop the sliding of the first axle in the operating position. This measure advantageously prevents the door handle from extending too far out of the motor vehicle door. Furthermore, the actuation stop also serves to shut off the drive that is used for extending the door handle. This could be realized by means of a microswitch that, for example, is operated by the operating lever and supplies a signal to the drive, in particular in order to switch off the supply of current in the case of an electric motor.

According to another preferred embodiment, provision is made that the first bearing section has a rest stop that serves to stop the sliding of the first axle in the rest position. This measure ensures in advantageous fashion that the door handle can return to its rest position that it previously occupied. Furthermore, the rest stop also serves to deactivate the drive when the door handle has reached the rest position. This could be realized by means of a microswitch that, for example, is operated by the operating lever and supplies a signal to the drive, in particular in order to switch off the supply of current in the case of an electric motor.

In order to make the design robust and simple, provision is made that the drive includes at least one eccentric element that drives at least the operating lever and/or the actuating lever.

To ensure a substantially linear extension of the door handle from the motor vehicle door, provision is made that the eccentric element is coupled to a guide lever implemented as a guide element, which engages a recess located in the operating lever. It is a great advantage that by means of the guide lever, which is connected to the eccentric element, a stroke extension of the door handle is possible on account of the kinematics present here. Thus, it is also possible that a further operating stroke of the door handle, in particular a folding motion of the door handle, can be executed after arrival at the operating position.

The extension of the door handle from the motor vehicle door is very reliable when the guide lever has a guide pin that is located in, and in particular engages, the recess of the operating lever.

According to another preferred embodiment, provision is made that the door handle is arranged flush with a motor vehicle door, in particular with a motor vehicle outer shell, when in the rest position. This improves the aerodynamics of the motor vehicle.

### BRIEF DESCRIPTION OF THE DRAWINGS

The invention is described on the basis of an exemplary embodiment. The figures show:

FIG. 1 a handle device according to the invention in a view from the front,

FIG. 2 the handle device according to the invention in a view from the back,

FIG. 3 the handle device according to the invention in a view from above,

FIG. 4 the handle device according to the invention in a view from below,

FIG. 5 the handle device according to the invention in a rest position in a side view,

FIG. 6 the handle device according to the invention in an operating position in a side view, and

FIG. 7 the handle device according to the invention in an operated position in a side view.

### DETAILED DESCRIPTION

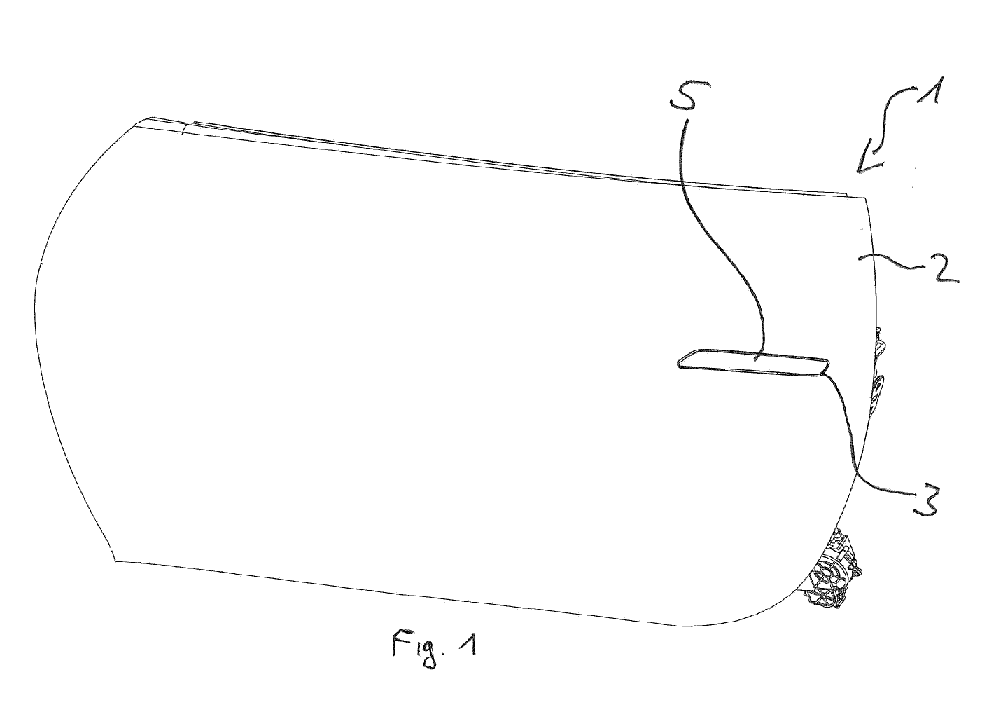

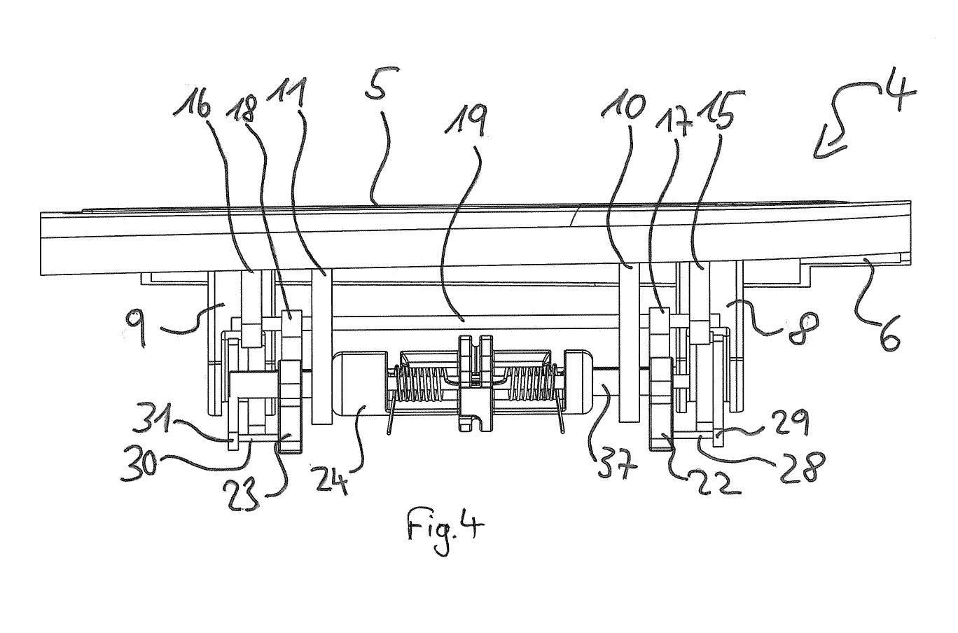

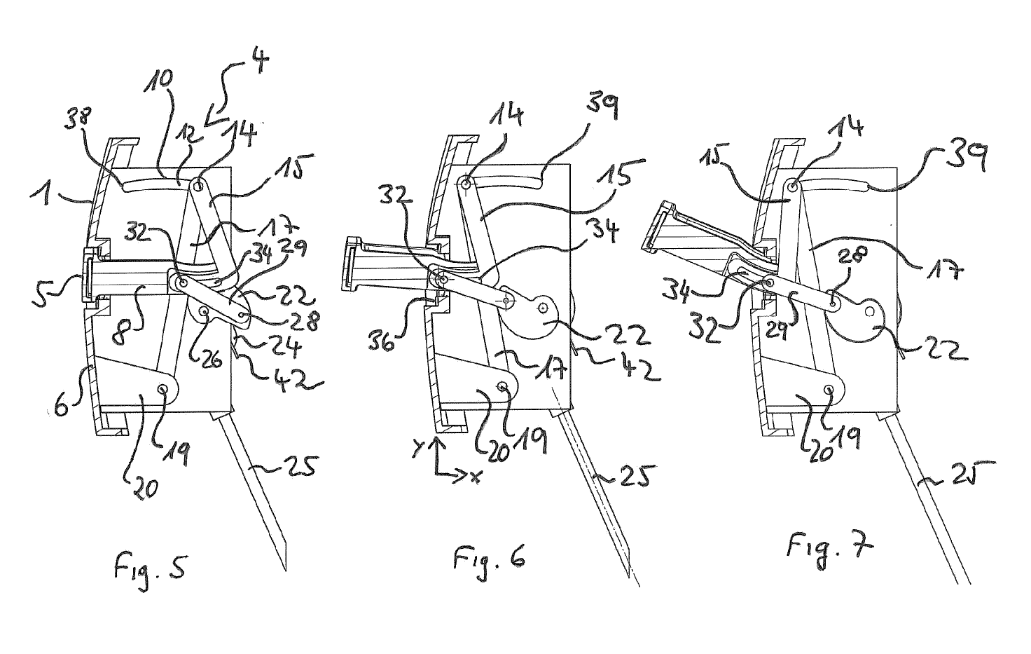

FIG. 1 shows a motor vehicle door 1 of a motor vehicle having a motor vehicle outer shell 2 made of sheet metal. The side door 1 has a cutout 3 in the motor vehicle outer shell 2 that is used for placement of a handle device 4 according to the invention for a motor vehicle. The handle device 4 includes, among other items, a door handle 5, which is arranged flush with the motor vehicle door 1, in particular with the motor vehicle outer shell 2, when in a rest position, as can be seen in FIG. 1 and FIG. 5. In FIG. 6, the door handle 5 is visualized in an operating position. In the operating position of the door handle 5, a user can pull the door handle 5 upward in the clockwise direction, which is to say away from a plane of the ground on which the vehicle stands, in order to operate a door lock that is not shown in detail.

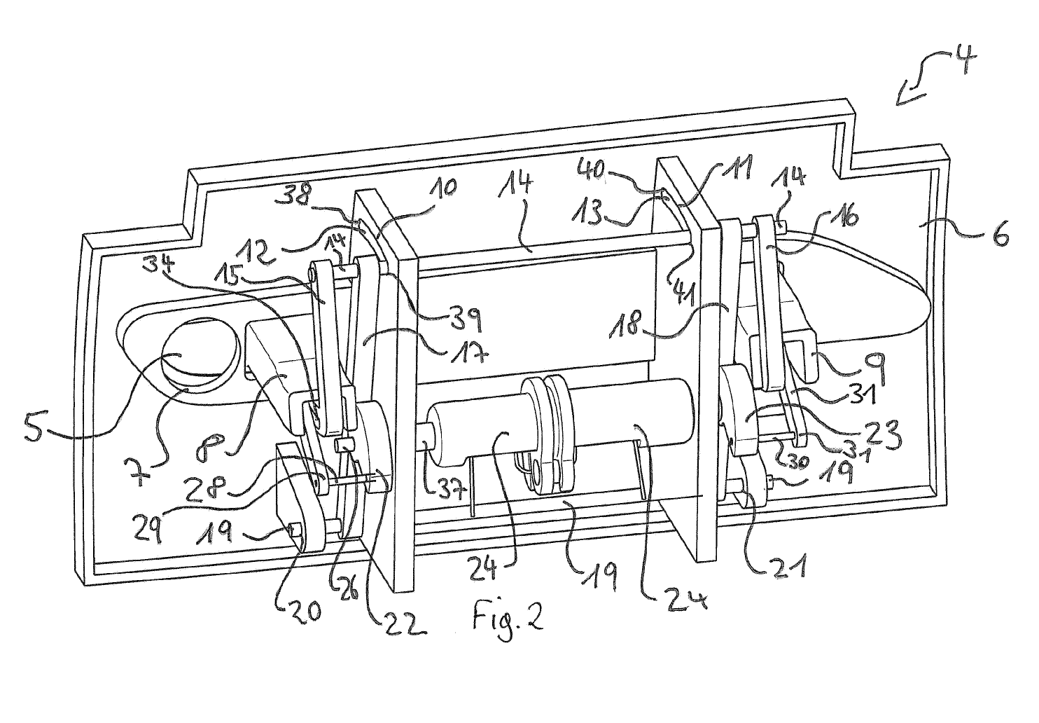

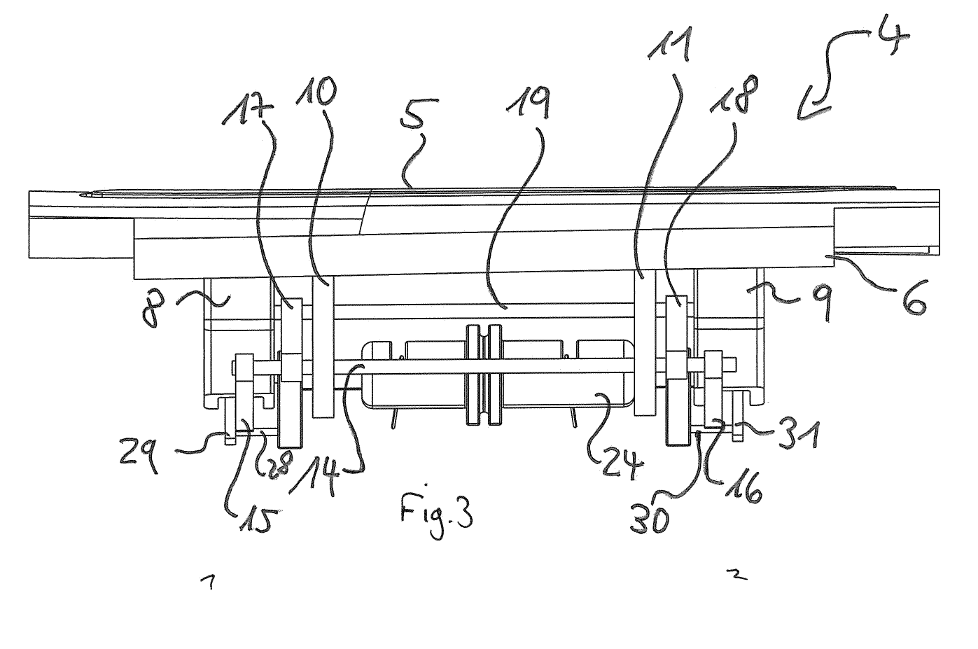

FIG. 7 shows the state of the operated position when the door handle 5 has reached its pulled end position. At this point in time, the door lock is being or has just been operated in order to unlock or open the motor vehicle side door 1. The handle device 4 also includes a support 6 with an opening 7 for a lock cylinder that is not shown in detail and the door handle 5, which is shown from the back as in FIG. 2. The door handle 5, having one of each handle finger 8, 9, is supported in the support 6. For supporting the door handle 5, the support 6 has a first bearing section implemented as a single part with the support 6; the first bearing section has a first bearing 10 and a second bearing 11, each of which includes a slot 12, 13 for supporting a first axle 14. The first slot 12, which serves as first bearing 10, has a first actuation stop 38 and a first rest stop 39. The second slot 13, which serves as second bearing 11, has a second actuation stop 40 and a second rest stop 41. The first bearing 10 and the second bearing 11 are implemented as a single part with the support 6, and both bearings 10, 11 serve to support the first axle 14.

The first axle 14, in turn, serves to pivotably support a first operating lever 15 and a second operating lever 16, wherein the first operating lever 15 is connected frictionally and/or positively to the first handle finger 8, and the second operating lever 16 is connected frictionally and/or positively to the second handle finger 9. In this design, the operating lever 15, 16 is implemented as a separate component and is connected frictionally and/or positively to the door handle 5. Alternatively, the operating lever 15, 16 can also be implemented as a single part with the door handle 5.

Furthermore, the first axle 14 also serves simultaneously to support a first actuating lever 17 and a second actuating lever 18, wherein the first actuating lever 17 and the second actuating lever 18 serve to couple the door handle 5 to the support 6. Moreover, the first actuating lever 17 and the second actuating lever 18 are additionally supported in a second bearing section so as to be pivotable about a second axle 19, wherein the second bearing section has a third bearing 20 and a fourth bearing 21, both of which bearings 20, 21 support the second axle 19. The third bearing 20 and the fourth bearing 21 are implemented as a single part with the support 6. A drive that is implemented as an electric motor is provided in order to transfer or move the door handle 5 from the rest position to the operating position. The drive additionally has two eccentric elements 22, 23, which are connected to a drive coupling element 24 by a shaft 37. The drive coupling element 24 is connected to the electric motor—which is not shown in detail—by a connecting element implemented as the rod 25.

Furthermore, the first eccentric element 22 has a first pin 26, in particular cylindrical pin, and the second eccentric element 23 has a second pin (not shown in detail), in particular cylindrical pin, wherein the pins each serve to drive the actuating lever 17, 18 when the electric motor is operated. Also arranged on the first eccentric element 22 is a first lever shaft 28, which joins the first eccentric element 22 and a first guide lever 29 implemented as a guide element to one another. In like manner, a second lever shaft 30, which joins the second eccentric element 23 and a second guide lever 31 implemented as a guide element to one another, is arranged on the second eccentric element 23. The first guide lever 29 and the second guide lever 31 each have a first guide pin 32 and a second guide pin (not shown in detail), each of which engage a first recess 34 or a second recess that is not shown in detail of the first or second operating lever 15, 16 in order to connect the eccentric elements 22, 23 to the door handle 5.

The following describes the kinematic sequence of motion, starting from the rest position, shown in FIG. 5, through the operating position, depicted in FIG. 6, to the operated position, visualized in FIG. 7. For the sake of simplicity, only the kinematics of one side of the handle device 4 are considered, as shown in FIGS. 5 to 7. The opposite side of the handle device has exactly the same kinematic structure and sequence at the same time.

In FIG. 5, the door handle 5 is in the rest position. In this position, the door handle 5 is arranged flush with the motor vehicle door 1, and rests against a circumferential sealing element 36 that is located on the support 6. The sealing element 36 advantageously prevents fluids and/or dust from getting into the interior space of the motor vehicle door 1, and thereby adversely affecting or damaging the kinematics, when in the rest position. In order to transfer the door handle 5 from the rest position to the operating position, the user can use a radio remote control, for example. In doing so, the user presses a button on the radio remote control that carries out the “open” command. Pressing the button activates the drive, in particular the electric motor, so that the drive coupling element 24 is moved via the rod 25. Since the drive coupling element 24 and the eccentric element 22 are connected in a fixed manner to the shaft 37, the eccentric element 22 accordingly also moves in the clockwise direction with respect to FIGS. 5 to 7. The first actuating lever 17 is driven by the pin 26 of the eccentric element 22, so that the first actuating lever 17 is transferred from the right-hand side of the first slot 12 to the left-hand side of the first slot 12. For this reason, the first bearing 10 has a first actuation stop 38, which serves to stop the sliding of the first axle 14 in the operating position. In order to ensure a substantially linear motion of the door handle 5 from the rest position to the operating position, the door handle 5 is positively guided by means of the recess 34, which is located in the first operating lever 15, and the first guide lever 29, in that the first guide pin 32 is guided in the self-contained first recess 34. Substantially linear extension of the door handle 5 is thus ensured when the first axle 14 is arranged so as to slide in the first bearing section, in particular in the first bearing 10, and the second axle 19 is arranged in a fixed location in the second bearing section, in particular in the third bearing 20, in the installed state. Within the meaning of the invention, “in a fixed location” means that the second axle could rotate, but cannot move in the x-direction or the y-direction in the cutting plane that is shown in FIGS. 5 to 6.

In the operating position, the electric motor is then switched off by the operation of a microswitch that is not shown. The microswitch could be operated by one of the levers.

As can be clearly seen in FIG. 6, in the operating position the first guide pin 32 is still located at the end of the first recess 34. If the user would now like to unlock and/or open the door lock, he pulls the door handle 5 by moving it upward in the clockwise direction. During this process, the first guide pin 32 moves in the opposite direction within the first recess 34, and strikes the other end of the first recess 34.

The door handle 5 is connected to a Bowden cable (not shown), which in turn is in operative connection with the door lock. Therefore, the motor vehicle door can by opened by pulling the door handle 5. When the door handle 5 is operated, at least the first actuating lever 17, the first guide lever 29, and the eccentric element 22 remain in the positions they occupied in the operating position. Because of this above-described kinematic arrangement, it is possible with a small installation space to nevertheless ensure linear extension of the door handle 5 in order to then execute a folding motion of the door handle 5 to open the door lock and the motor vehicle door.

In order to return the door handle 5 to the rest position again, the user lets go of the door handle 5. By means of a spring element 42 that is supported on the second axle 19, the door handle 5 that is coupled to the spring element 42 is returned to the operating position. After a predetermined period of time, the electric motor is activated again and moves the door handle 5 back to the rest position. During this process, the axle 14 in the first slot 12 shifts back into the position it had in the rest position. The first bearing section, in particular the first bearing 10 which includes the first slot 12, thus has a second stop 39 that serves to stop the sliding of the first axle 14 in the rest position.

As a basic principle, the actuating lever 17, 18 is designed to be longer than the operating lever 15, 16. The actuating lever 17, 18 should be twice as long as the operating lever 15, 16 in design.

It is a great advantage of the invention that by means of the guide lever 29, 31, which is connected to the eccentric element 22, 23, a stroke extension of the door handle 5 is possible on account of the kinematics present here. Thus, it is also possible that a further operating stroke of the door handle 5 in the clockwise direction according to FIGS. 5 to 8 can be executed after arrival at the operating position.

1. A handle device for a motor vehicle, the handle device comprising:
a door handle,
at least one operating lever that is supported so as to pivot about a first axle,
a support for supporting the door handle,
at least one actuating lever for coupling the door handle to the support, wherein the actuating lever is supported so as to pivot about a second axle,
a first bearing section located on the support for supporting the operating lever,
a second bearing section located on the support for supporting the second axle,
at least one guide element for positive guidance of the door handle and/or of the operating lever,
a drive, in particular an electric motor, for moving the operating lever and/or the actuating lever, and
a door lock that is coupled to the door handle,
wherein the first axle is arranged so as to slide in the first bearing section, and the second axle is arranged in a fixed location in the second bearing section in an installed state.

2. The handle device according to claim 1, wherein the actuating lever is longer than the operating lever.

3. The handle device according to claim 2, wherein the actuating lever is twice as long as the operating lever.

4. The handle device according to claim 1, wherein the actuating lever is implemented as a separate part and is frictionally and/or positively connected to the door handle.

5. The handle device according to claim 1, wherein the operating lever and the door handle are implemented as a single part.

6. The handle device according to claim 1, wherein the first bearing section has an actuation stop that serves to stop the sliding of the first axle in an operating position.

7. The handle device according to claim 1, wherein the first bearing section has a rest stop that serves to stop the sliding of the first axle in a rest position.

8. The handle device according to claim 1, wherein the drive includes at least one eccentric element that drives at least the operating lever and/or the actuating lever.

9. The handle device according to claim 8, wherein the eccentric element is coupled to a guide lever implemented as a guide element, which engages a recess located in the operating lever.

10. The handle device according to claim 9, wherein the guide lever has a guide pin that is located in, and engages, the recess of the operating lever.

11. The handle device according to claim 8, wherein the eccentric element has a cylindrical pin that serves to drive the actuating lever.

12. The handle device according to claim 1, wherein the door handle is arranged flush with an outer shell of a motor vehicle door when in a rest position.

13. A handle device for a motor vehicle, the handle device comprising:
a support;
a door handle movable relative to the support between a rest position and an operating position;
an operating lever coupled to the door handle;
an actuating lever pivotally coupled to the support and the operating lever;
a guide element pivotally coupled to the operating lever;
an eccentric element pivotally coupled to the guide element; and
a driver configured to rotate the eccentric element relative to the guide element and move the door handle between the rest position and the operating position.

14. The handle device according to claim 13, wherein the support includes a bearing portion translatably coupled to the actuating lever.

15. The handle device according to claim 14, wherein the bearing portion includes at least one of an actuation stop or a rest stop, the at least one of the actuation stop or the rest stop operable inhibit movement of the actuating lever relative to the support.

16. The handle device according to claim 13, wherein the guide element is translatably coupled to the operating lever.

17. The handle device according to claim 16, wherein the operating lever includes a recess, and wherein the guide element is translatably disposed within the recess.

18. The handle device according to claim 13, further comprising a door lock coupled to the door handle.

19. The handle device according to claim 13, wherein the actuating lever is longer than the operating lever.

20. The handle device according to claim 13, wherein the door handle is arranged flush with an outer shell of a motor vehicle door in the rest position.
